(19) United States
(12) Patent Application Publication
(10) Pub. No.: US 2013/0035928 A1
(43) Pub. Date: Feb. 7, 2013

(54) TxtAnalizer

(71) Applicant: Hristo Tzanev Georgiev, Walenstadt (CH)

(72) Inventor: Hristo Tzanev Georgiev, Walenstadt (CH)

(21) Appl. No.: 13/198,392

(22) Filed: Aug. 4, 2011

(51) Int. Cl. G06F 17/27

(52) U.S. Cl. 704/9

(57) ABSTRACT

Text to motion pictures software program working on sentences that can have visual interpretation: you type in the sentence, the program understands the meaning of the sentence (that means one can say the same thing in other words) and starts an external process, a video file. The video file closes itself after the video finishes and the program is ready to process the next sentence.

### CROSS-REFERENCE TO RELATED APPLICATIONS

None.

### STATEMENT REGARDING FEDERALLY SPONSORED RESEARCH OR DEVELOPMENT

We state that we have no federally sponsored research or development.

### THE NAMES OF THE PARTIES TO A JOINT RESEARCH AGREEMENT

1. Hristo Tzanev Georgiev, Swiss citizen, Switzerland

2. Maria-Theresia Georgiev(-Good), Swiss citizen, Switzerland

### INCORPORATION-BY-REFERENCE OF MATERIAL SUBMITTED ON A COMPACT DISC

None.

### BACKGROUND OF THE INVENTION

1. Field of the Invention

The present invention relates to a Natural Language Text Processing System able to process, to parse (to analyse)
morphologically the input word entries,
syntactically and grammatically the input phrases and sentences,
semantically, the input words, phrases and sentences.
   The transformation of the text into motion pictures cannot be achieved without accurate parsing of the input sentence or text. The parsing itself is a complex process, involving other interdependent processes, such as morphological, grammatical, syntactical and semantical analysis of the sentence or the entire text.

2. Background Art

Problem solved by the invention and solution to this problem.

There are many problems that can be solved with this invention. For example, one can have reading and writing problem, but he or she can look at a text, type it in, letter by letter, and by pressing “Enter” on the keyboard, see on a video what is meant.

Another example would be that one has a problem activating, in writing, a remote device or machine, connected with ones computer. Our computer program will understand the written command and will activate the remote machine or device in the same way as it activates the video program with the correct video file. Similarly, the problem can be stopping a remote device or machine with a written command.

### BRIEF SUMMARY OF THE INVENTION

Using Natural Language Text Processing techniques, a written text is transformed into motion pictures, a video, that describes visually the meaning of the sentence or of the entire text.

### BRIEF DESCRIPTION OF THE SEVERAL VIEWS OF THE DRAWING(S)

No drawings.

### DETAILED DESCRIPTION OF THE INVENTION

The programming language used in the invention is C/C++.

The morphology of the word is described in a *.cpp file as follows

if (morsyn == A_SYN)
{

if (dicsyn == V_SYN || dicsyn == Z_SYN ||

dicsyn == E_SYN || dicsyn == _E_SYN || dicsyn ==
I_SYN)

{

wrd−>syn = A_SYN;

wrd−>tense = T_PAST;
if (subflx == 24)

wrd−>tcase = C_DAT;

}
// etc.

and in an *.h file, as follows

| struct MORPH_FLEX en_endflex[ ] = | |
|---|---|
| { | |
| “est”, | “d2”, NULL, 3, |

| | |
|---|---|
| “al”, | “d2”, NULL, 2, |

| | |
|---|---|
| “ally”, | “d2”, NULL, 4, |

| | | |
|---|---|---|
| “ly”, | “D”, | NULL, 2, |
| “d”, | “V”, | NULL, 1, |
| “s”, | “V”, | NULL, 1, |

| | | |
|---|---|---|
| “d”, | “E”, | NULL, 1, |
| “ed”, | “E”, | NULL, 2, |
| “s”, | “n”, | NULL, 1, |

// etc.
NULL
};

The syntax (Part of Speech, sometimes, Part of the Sentence of the word or phrase) is described in a *.cpp file as follows

| | |
|---|---|
| case 3: | /* Xd] */ |

if (wrdm−>E.W.afterv || wrdm−>E.W.should || wp[mpos+1]−>syn ==
B_SYN)

wrdm−>syn = D_SYN;

else

wrdm−>syn = A_SYN;

if (wp[mpos+1]−>syn == B_SYN)
wp[mpos+1]−>syn = _B_SYN;

CopySyn( );

i = mpos; continue;

case 4:

for (x = i; x < mpos && wp[x]−>syn != _D_SYN; x++);
if ((wp[x]−>S.B.time && (wrdm−>S.B.time || wrdm−>esyn == I_SYN)
&&
wp[x]−>E.W.noun) || (wp[x]−>E.W.noun && !wp[x]−>E.W.beforen) )

wp[x]−>syn = N_SYN;

else

wp[x]−>syn = A_SYN;

CopySyn( );

i = mpos; continue;

case 32:

if (wrdp−>E.W.adj && !wrdp−>numb)
{
wrdp−>syn = A_SYN;

CopySyn( );

}
i = mpos; continue;

and in an *.h file, as follows

| {“X<KD>d”, | NULL, | 3}, |
|---|---|---|
| {“[PV]d[ZG]”, | NULL, | 4}, |
| {“A[,C]<KD>[ZN][;)}JPB*]”, NULL, 32}, | | |
| {“\grave{ }pending\grave{ }T”, | “P”, | }, |

// etc.

The meaning, the semantic component of the word or phrase, is described in a *.cpp file as follows

case ‘q’:

G−>W.illness = 1;

break;

case ‘Ÿ’:
G−>W.hit = 1;
break;

case ‘½’:

G−>W.writing = 1;

break;

// etc.

In an *.inl file we declare the same meanings once again, as follows

if (g−>W.illness) *c++ = ‘q’;
if (g−>W.hit) *c++ = ‘Ÿ’;
if (g−>W.writing) *c++ = ‘½’;

In one *.h file we declare the meaning a word or phrase can have

| | |
|---|---|
| unsigned illness | : 1; |
| unsigned hit | : 1; |
| unsigned writing | : 1; |

We declare the meaning once again in another *.h file

| | |
|---|---|
| uchar | illness; |
| uchar | hit; |
| uchar | writing; |

We declare the Part of Speech and the meaning in the database, as follows

jaundice*N[q]jaundice
hit*e[ifl]hitNhitCcrashLhitFhit
newspaper*N[¢]newspaper
john*N[NHM]john

where
N is an abbreviation for Noun
e is an abbreviation for Verb (Present or Past or Participle) or Noun

In square brackets [ ]
q is an abbreviation for illness
f is an abbreviation of a concept, comprising a number of synonyms denoting “hit”
H is an abbreviation for a human being, a person
   And, finally, when we have laid the foundations of our morphological, syntactical and semantical analysis, we can start writing our commands, when what should be done, in another *.cpp file, as follows

case 137:
if (wrd−>E.W.human != 1) break;
if (wrdm−>E.W.illness && wrd−>E.W.human) {

| | |
|---|---|
| // | (void)system(“moviemk.exe illness.avi”); |
| // | the above is for Windows Vista |

(void)system(“ill-ness.wmv”);

// the above instraction starts the Video Program in Windows 7

Sleep(9000); // stay so till the end of the Video
system(“taskkill /IM wmplayer.exe /F”);

// close the video file ill-ness.wmv

}
CopySyn( );
i = mpos; continue;
case 185:
if (wrd−>E.W.hit && (wrdm−>E.W.animated

|| wrdm−>E.W.human)) {

(void)system(“hit.wmv”);
Sleep(5000);
system(“taskkill /IM wmplayer.exe /F”);
}
CopySyn( );
i = mpos; continue;
case 186: // 2011
if (!stricmp (wrd−>inword, “read”) ||
!stricmp(wrd−>inword, “reads”)

&& wrdm−>E.W.writing) {

(void)system(“read.wmv”);
Sleep(5000);
system(“taskkill /IM wmplayer.exe /F”);
}
CopySyn( );
i = mpos; continue;

The above instructions have a continuation in an *.h file to specify the position of each word in context

| | |
|---|---|
| {“[RN]<XYAVueP>N”, | NULL, 137}, |

| | |
|---|---|
| {“[VEhue]<TA>N”, | NULL, 185}, |
| {“[VEhue]<TA>N”, | NULL, 186}, |

As a result of the instructions above, such sentences as
Susan kicked John.
or
He hit the soldier.
will trigger a short video showing somebody hitting somebody else.
The sentence
John has jaundice.
or
John suffers from malaria.
will trigger a short video showing somebody being carried away in a
stretcher.
The sentence
He reads a newspaper.
will trigger a short video showing somebody reading a newspaper.
The sentence
John has jaundice, Susan reads newspaper.
will trigger two successive short videos showing the respective scenes.

### KEYWORDS

Text visualisation, Text to video conversion, Text to motion pictures conversion, Visual interpretation of texts, Understanding the meaning of the word, Understanding the meaning of the phrase, Understanding the meaning of the sentence, triggering external process,

1. For a computer-implemented invention, whose implementation requires a computer. Our invention is a computer program, consisting of a great number of commands for a computer, about one million such commands, that fulfil the specific functions described below.
This is computer-readable medium having a program implementing the following processes: the program reads the user input, a written sentence, in English (or German), understands the meaning of the sentence and if the sentence contains phrases or parts that can be depicted visually, displays a short video, the video file closes itself automatically after the video finishes, the software program corrects automatically the orthographical and grammatical errors in the input sentence, if any, and displays the corrected sentence. After that the program is ready to process the next sentence. The process described above is tied to a machine (a computer hardware that runs the software). The process transforms the written text, in our case a sentence, into motion pictures. In other words the meaning of the text is converted into motion pictures. So, one can see in a visual form what was meant in the sentence that was processed. This technique can have many other applications in text processing, for example, depending on the meaning of the sentence, which can be a written command, the software program can trigger, switch on or off other, external processes, other machines. This process, as described, can be applied to other languages as well.
The software system, as described above, is a process for transforming data using computing and communication hardware.
